(19) United States
(12) Patent Application Publication
(10) Pub. No.: US 2011/0025492 A1
(43) Pub. Date: Feb. 3, 2011

(54) Personal Object Proximity Alerting Device

(76) Inventor: Andres E. Bravo, Pompano Beach, FL (US)

Correspondence Address: Andres E. Bravo, 1050 NW 49th Street, Pompano Beach, FL, 33064, US

(21) Appl. No.: 12/534,144

(22) Filed: Aug. 2, 2009

(51) Int. Cl. G08B 21/00; G08B 1/08

(52) U.S. Cl. 340/539.11; 340/686.6

(57) ABSTRACT

Utilizing an electronic means to assist in a sensory and situational awareness deficit setting is the prime function of the invention. With the advent of low voltage, miniature and very economical proximity sensing devices, opportunities to employ those devices to substitute or assist the human senses have resulted in the invention. Requiring only the sense of touch, a person will be alerted of the presence of inanimate and warm bodied objects while simultaneously tracking and conveying their distance. By applying the invention in settings experiencing various forms of visual impairment, the user will more safely traverse through obscure territories without collision into nearby objects. Applying various methods of proximity and motion detection will increase the reliability of the apparatus, with enhanced configurations able to distinguish between types of detected objects as well as increase precision in a range of environments. Low cost components, having minimal numbers of components per unit, and ease of assembly increases accessibility to and applications for the invention to include casual, sport, disability, personal security, military, and scientific. The invention is manufactured in miniature form, and as an assembly of multiple units it will create a pattern of tactile alerts representing the direction of different objects within the detection range. Transforming a visual event into a tactile response is how the invention has created a method of proximity detection and alerts which remedy the experience of reduced awareness to the presence of objects, persons, or animals.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Awareness to the proximity of surrounding objects allows an individual to determine one's position relative to those objects, occurring mainly through visual perception. Assisting and improving that awareness by technological means will improve existing abilities, as well as assist in settings of limited visual clarity or opportunity. Miniature vibrating devices are currently used to provide various types of alerts through placement against the skin where the body's pressure sensors pick up the tactile vibrations. In the same manner, a small vibrating device can be used to alert of an approaching object when activated and controlled by miniature proximity sensors. An analog signal produced from an energized low voltage ranging device will activate a vibrating micro motor to produce vibrations with intensity inversely proportional to the distance to the object. As the object approaches the sensor and the distance decreases, the sensor responds by increasing the power of the output signal, causing the vibrations to increase. By using this type of personal proximity device, scenarios having limited visual cues can be remedied through the tactile vibrations, occurring at proportional intensities, produced by a proximity device that alerts the user of distance to an object from several feet away before the object approaches to an unsafe or unavoidable range. The distance to the detected object is conveyed to the user as the vibrations from the proximity device increase in intensity. An increased resolution of sensation from a collection of sensors and accompanying vibrating micro motors will increase the detail of the sensory event as the vibrations produced in collective form can recreate the sensation of awareness to nearby small or abundant objects in more detailed form. Use of numerous miniature vibrating devices to provoke sensory responses when assembled in the form of a personal wearable device can be utilized to project event signals from video games or other digital or analog media as well.

By alerting the user of changed or changing conditions without visual cues, the apparatus can be applied to assist with visual impairment, to include visual limitations resulting from environmental or situational conditions. Using vibrating micro motors similar to those employed in cellular phones, each wired to its own low voltage ranging device, and placed in hat or helmet form over and on the head, the total concept and assembly will provide the user with vibrating alerts as the proximity of local objects changes in the direction where the event took place. In total darkness, when positioned in contact with the user, the apparatus will through vibrations alert the user of approaching objects, with the intensity of the produced vibration changing relative to the distance to the object.

### BRIEF SUMMARY OF THE INVENTION

The primary purpose of the invention is to provide ranging and object presence feedback through tactile vibrations, activated in the direction of the detected event to reveal distance, with varying intensity inversely proportional to the distance to the detected object.

By utilizing a low voltage miniature infrared, ultrasonic, electromagnetic or other motion detection or ranging device, the assembly will provide a tactile vibrating signal with intensity relative to the distance to the detected object. The invention will provide a greater sense of security when moving through areas having unknown obstacles and little or no opportunity for vision. By activating the localized tactile vibrations, directional ranging sensors will alert of approaching or nearby objects from a few inches to a few feet away. To alert in the event of a human or animal presence, infrared motion detection devices would be employed to activate the vibration in the direction where the object was detected with a radius of detection exceeding over ten feet. As with infrared ranging devices, motion detectors are also currently available in low voltage miniature form.

Applying the invention for walking, jogging, or cycling through obacure territory during the night or day will provide a security benefit through infrared motion detection. The invention will immediately alert using silent tactile vibrations of any new presence approaching from behind or other direction not currently in the line of sight. For the military, use of invention on a helmet will increase the security and safety of a soldier by quietly signaling the user of physical changes in local surroundings to include unaccounted human or animal presence, where through darkness or other visual restriction, sight could not contribute to the immediate situational awareness. For the sight impaired, having motion and distance detection in headwear or other wearable configuration where sensors could also be directed downward to detect furniture or other smaller obstacles, walking throughout a house or building is facilitated, to include those individuals that lose their vision at a later stage in life and must learn the process of walking without sight.

Miniature PIR (Passive Infrared) devices are mass-produced and available economically. Adapted to a vibrating micro motor, and utilizing one resistor and one transistor, a vibrating PIR assembly can be produced. These small and economical assemblies can be placed in single or collective form on clothing, headwear, eyeglasses, shoes, and other wearable methods to alert the user of object proximity concerns. Having 4 or more units of the invention circumscribed about a hat or helmet, the user can commute through dark pathways or areas of multiple obstructions or dangers with the ability to sense oncoming or out of sight objects before they would normally have been detected under similar conditions. Ultrasonic ranging devices can also be used and are more effective in some areas vs. PIR, but are less economical and draw more power from the voltage supply. The concept as well as the manufacturing of the invention is basic and with the controlling electronic elements manufactured as solid state, exposure to physical disturbances would not necessarily interfere or hinder the operation of the device. Moreover, the invention will include a waterproof configuration, which will extend the life of the electronic components. Utilizing a rechargeable power source would further extend the frequency of usage, as well as contribute to a cleaner environment through lack of discarded batteries.

The invention is focused mainly on miniature personal proximity and motion detection with silent tactile vibration alerting at an economical cost. Additionally, the localized vibrating device can also be utilized in conjunction with a digital input signal as produced by computer software, more specifically video games or virtual reality programs. A collection of vibrating micro motors configured as head gear, gloves or other configuration where the tactile vibrations of the apparatus can be felt will provide real time feedback to events and scenarios. Whether used as proximity detection or in virtual reality environments, the use of vibrating micro devices worn on the body to connect the user to some external event or setting on a real time basis will provide a greater level of real or virtual environment situational awareness and personal security.

### BRIEF DESCRIPTION OF THE DRAWINGS

In the drawings:

FIG. 1 shows an electrical schematic of the circuit required to convert an analog output signal from the proximity infrared detector to a proportional output signal sufficient to energize the vibrating motor.

FIG. 2 shows an electrical schematic of the circuit required to divert an output signal from the infrared motion detector to an output signal sufficient to energize the vibrating motor.

FIG. 3 shows an electrical schematic describing the parallel power source method as it would be applied to the plurality of devices within the assembly.

FIG. 4 shows a plan view of the invention as applied to personal head gear and a conceptual representation of the objects of interest it detects.

FIG. 5 shows a plan view of the invention configured in belt form for personal use.

FIG. 6 shows an isometric view with cut section of outer cover omitted to observe application of invention configured in belt form for personal use.

FIG. 7 shows a side view of the invention configured in belt form for personal use.

FIG. 8 shows a plan view of the invention in polar array arrangement as applied to the head gear for personal use.

FIG. 9 shows an isometric view of the invention arranged in polar array as applied to the head gear for personal use.

FIG. 10 shows a front view of the invention arranged in polar array as applied to the head gear for personal use.

FIG. 11 shows a side view of the invention arranged in polar array as applied to the head gear for personal use.

FIG. 12 shows a plan view of the invention in reverse direction facing configuration applied to a helmet for personal security use.

FIG. 13 shows an isometric view of the invention in reverse direction facing configuration applied to a helmet for personal security use.

FIG. 14 shows a side view of the invention in reverse direction facing configuration applied to a helmet for personal security use.

FIG. 15 shows a back view of the invention in single reverse facing arrangement as applied to the helmet described.

### DETAILED DESCRIPTION OF THE INVENTION

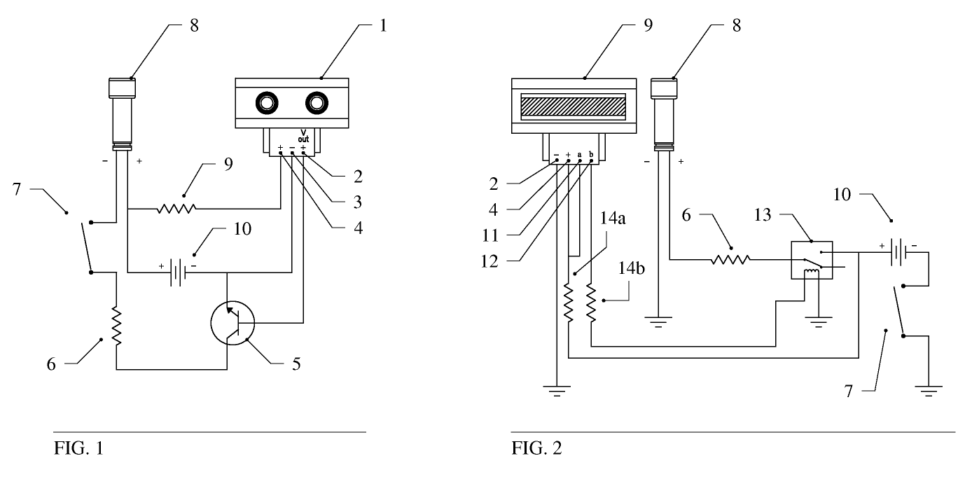

The invention is defined by the use of vibrating tactile alerts to physically notify the user of proximity and motion detection events. An electrical power source energizes an assembly of miniature proximity or motion detection devices, each with a miniature electrical vibrating device, whereby the vibrating device is energized in accordance with the signal output produced by the proximity or motion detection device to which it accompanies. FIG. 1 illustrates the electrical method to energize vibration device 8 proportional, and in response to an output signal from proximity detection device 1. In this schematic description, the proximity device 1 receives its power supply from voltage source 10 into source input 4 and 3. Once an output signal from detection device 1 is triggered by a proximity event, a positive electrical analog output current is channeled through 2, proportional in power to the distance to the detected object. Since the required electrical energy to activate the vibrating motor is typically greater than the output signal from the proximity detector 1, an electrical switching device is employed to amplify the analog signal to operationally sufficient levels. A solid state transistor 5 is described in FIG. 1 to accept the electrical output signal as the base trigger voltage. For the purposes of this configuration, an NPN type transistor is utilized since proximity device 1 provides a positive output signal, which is directed to the base of transistor 5 to regulate the electrical current flow to vibrating device 8. In the event that the output signal from proximity detection device 1 is negative, transistor 5 would be PNP type, as its base would accept a negative voltage to trigger the current flow from the emitter to the collector. The difference in power requirements between proximity detection device 1, vibrating motor 8 and transistor 5 is accommodated with resistors 6 and 9, whereas resistor 6 reduces the power supplied to the vibrating motor 8 to an operational level, and similarly resistor 9 reduces the power supplied to proximity detection device 1 to an operational level. Multiple detection units on a common power supply will determine resistance values for resistor 6 and 9 since less power is provided to each individual device as the quantity of devices in the assembly increases. Activation of the proximity detector assembly is achieved via user switch 7. Circuit configuration shown on FIG. 1 satisfies the parameters dictated by proximity detector 1. Proximity and motion detectors of alternate electrical configurations will require alternate circuit configurations to ensure that an output signal from the detector is transformed into an electrical power source for the vibrating device.

FIG. 2 illustrates the electrical method to energize vibration device 8 in response to an output signal from motion detection device 9. Utilizing the same concept as with proximity detector 1, motion detector 9 will provide a constant output signal triggered by a motion detection event, energizing vibrating motor 8. Power source 10 will provide sufficient voltage and electrical current to energize motion detector 9 at inputs 2 and 4, as well as vibrating motor 8. For the purposes of the schematic described in FIG. 2, and the electrical configuration of motion detector 9, contacts 11 and 12 provide a closed electrical connection between relay 13 and power source 10 while the motion detector 9 is energized but experiencing no detected event. In response to a motion detection event, motion detector 9 will open the electrical connection between contacts 11 and 12. For this reason, FIG. 2 describes a circuit that energizes vibrating motor 8 when the electrical connection between contacts 11 and 12 opens. Relay 13 is energized initially as contacts 11 and 12 on motion detector 9 provide a closed circuit between itself and power source 10. With motion detector 9 in its energized state, relay 13 is initially activated to close a null connection to power source 10, opening the opposing connection to vibrating motor 8, preventing it from operating. During a motion detection event, motion detector 9 opens the electrical connection between contacts 11 and 12, cutting the connection between power supply 10 and relay 13. As relay 13 deactivates, its unused null connection opens, closing the electrical connection between power supply 10 and vibrating motor 8 through resistor 6 to decrease the voltage to an operational level, activating the unit,. The output signal from motion detector 9 is a constant voltage lasting a predetermined period of time before motion detector 9 resets for its next motion detection response.

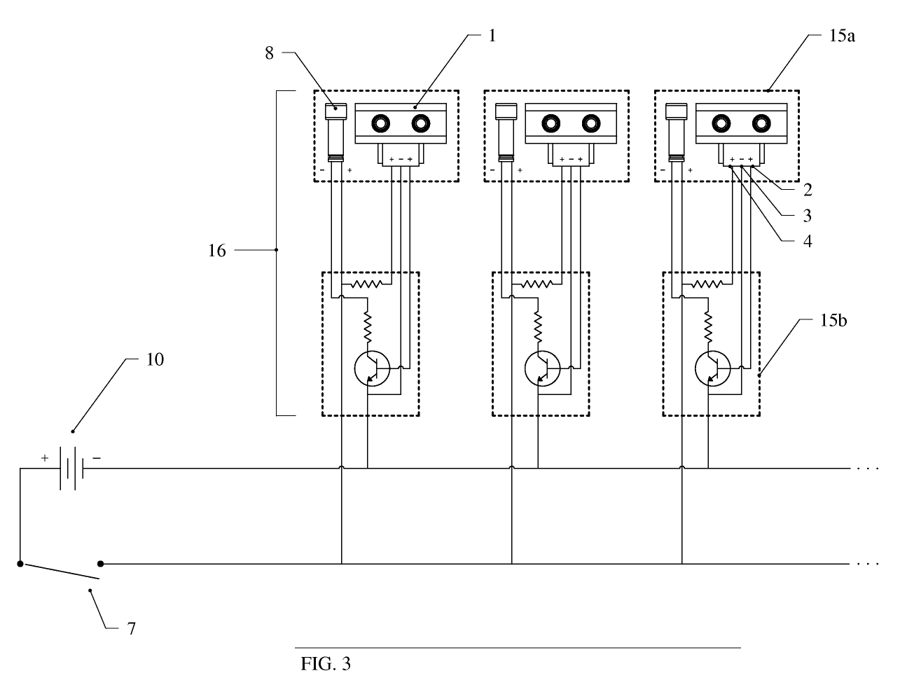

For applications where multiple units of the invention are employed as one assembly, a parallel connection from each individual unit to a common power supply would be required as described in FIG. 3. Each vibrating proximity and motion detecting unit 15a would receive its power distribution from circuit 15b with positive and negative power inputs connected in a common and parallel configuration to power supply 10. Increase in assembly of units 16 per common voltage source 10 would require an increase in level of power to satisfy the dispersed electrical loads throughout assemblies. A common switch 7 would open or close the connection to power source 10, thereby activating or deactivating the invention 16.

The visual representation provided by FIG. 4 describes the general purpose of invention 20 as providing local object proximity awareness alerts in the form of tactile vibrations to the user through direct physical contact via headwear, in the vicinity of those objects. The plan view positions user 17 with inanimate obstacles 19 in front, left, and right, and person 18 directly behind. User 17 is wearing the invention 20 as head gear, with sensor units within the assembly circumscribed about the head, allowing for motion and proximity detection in a 360 degree range. Invention 20 will provide proximity ranging in any direction, but generally the motion detection would be directed back to alert of approaching objects or warm bodies 18 from behind at a greater distance, where infrared motion detection will distinguish between an inanimate object and a warm body. As user 17 moves in the direction of inanimate objects 19, the proximity ranging feature of the invention will provide a vibrating tactile alert which increases as the distance to objects 19 decreases. Person 18 positioned directly behind user 17 will trigger the infrared motion detection device signal output once the heat signature produce by person 18 is picked up by the motion detection assembly 20, which can be configured to occur 10 feet or further from user 17.

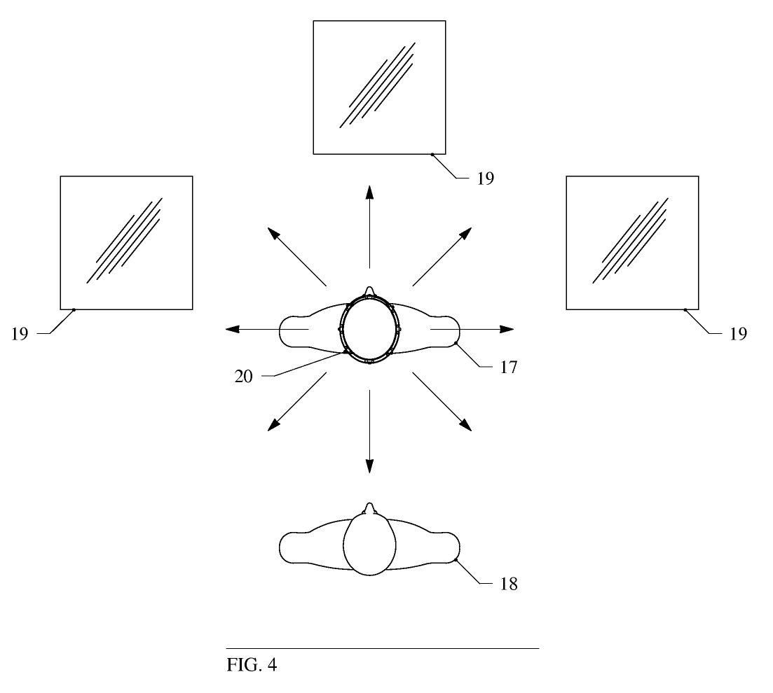

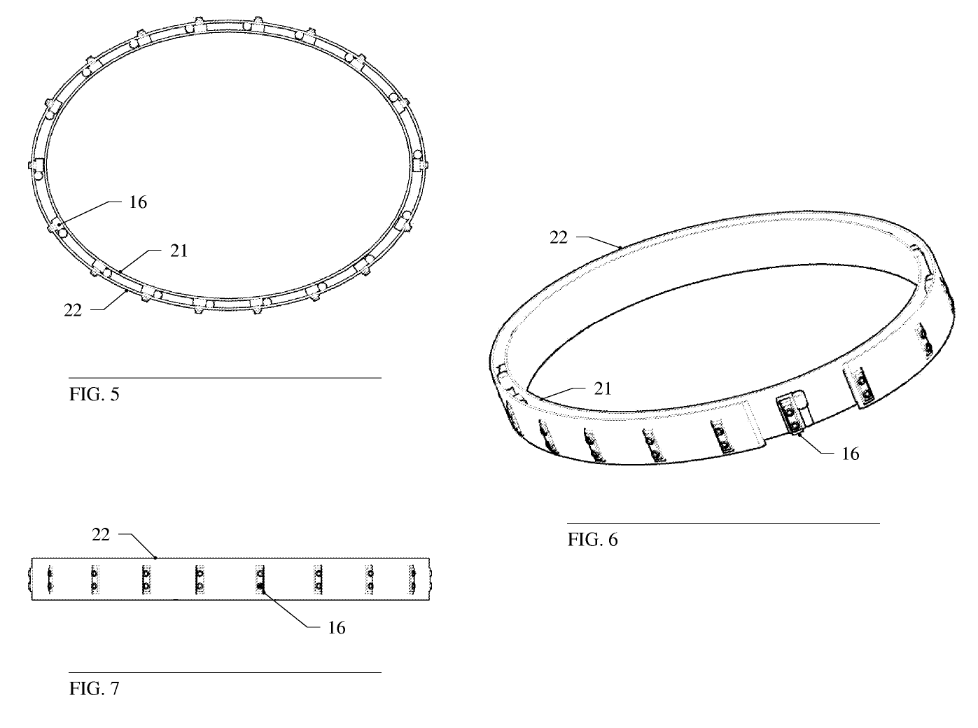

According to FIG. 5, the invention 16 is positioned in polar array configuration circumscribed around a user's torso or waist. Each unit 16 in the assembly is positioned at its location using flexible belt material 21 and 22 employed in a circular form, the radius and circumference determined by the person around whom the final configuration is set. The quantity of units 16 per assembly is dependent on the application to which it will be assigned. Invention 16 can be worn on a person's head in hat, helmet, and headband form, as well as a waist belt and any other location of convenience and interest on a person's body. FIG. 6 displays an isometric view of the invention 16 in belt form with a cutout of belt material 22 to display the concealment of invention 16 between belt material 21 and 22.

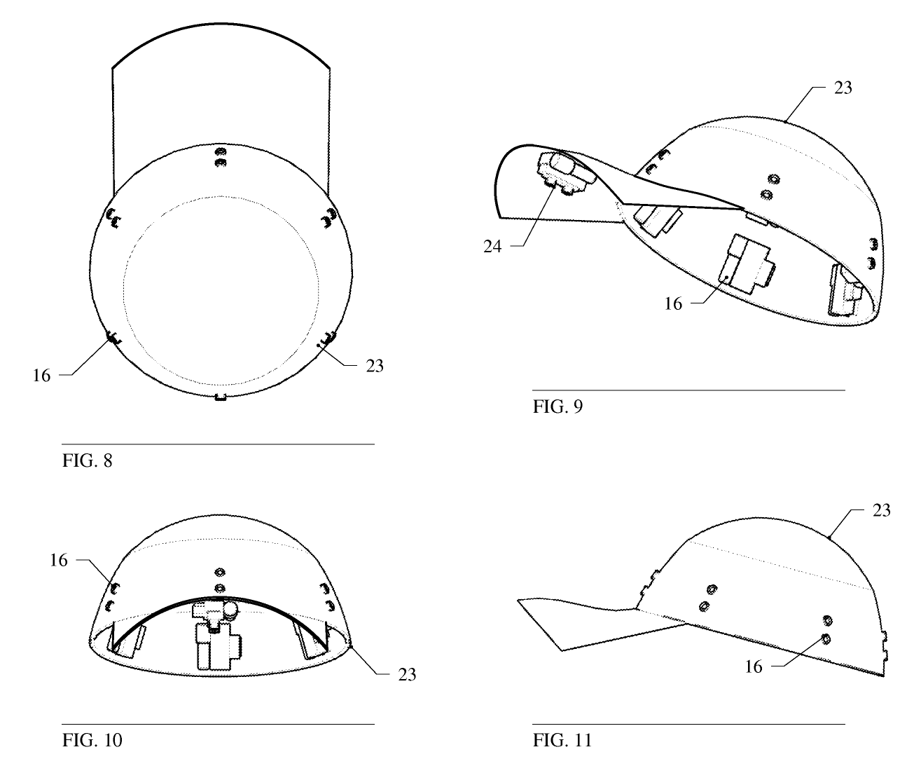

In the same arrangement as shown on FIGS. 4, 5, and 6, applying the invention 16 in head wear form would allow for proximity and object awareness at a 360 degree perspective. FIGS. 8, 9, 10, and 11 describe a configuration and application for invention 16 in hat form, in this case a sport cap. Invention 16 can be sewn into head gear 23 in a circular array, circumscribed around the head, and within the material of the hat 23. Utilizing the front flap of hat 23, a downward facing arrangement 17 is achieved to detect and alert the user through localized tactile vibrations the presence and proximity of objects at lower elevations as they approach or are approached. The invention 16 is functional in sealed form and can therefore be waterproofed to prolong the use of its operation. Due to the miniature size of invention 16, the presence of the detection and vibration components can be concealed and provide an unnoticed security measure for the user.

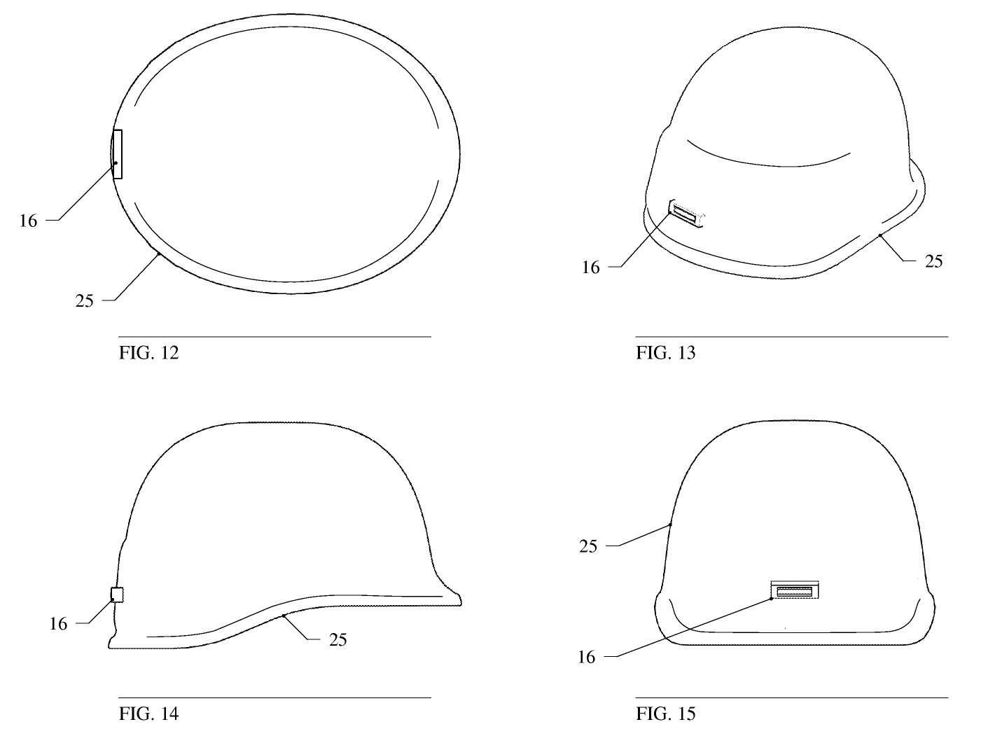

As described in FIGS. 12, 13, 14, 15, and 16, invention 16 can be mounted as a motion detector facing rearward relative to the user. Motion detection device 16 will trigger the vibration component of its assembly in the presence of warm bodied objects at a significant distance of over 10 feet. For this reason, invention 16 can be employed in military and other security industry applications by positioning the assembly within a helmet. In this configuration, invention 16 will alert the user as a warm body approaches from behind and any other direction considered out of the line of site with units of invention 16 pointing in those directions. As the security benefit, when a warm body is detected by invention 16, the apparatus will quietly and exclusively notify the user allowing for a calculated and unannounced response.

What I claim as my invention is:

1. A portable distance ranging or motion detection apparatus which communicates a detection alert signal to its user through tactile vibrations.

2. An arrangement in accordance with claim 1, wherein; the apparatus is manufactured in miniature form and where multiple units of the invention are arranged in collective configuration to provide source direction.

3. An arrangement in accordance with claim 2, wherein; the apparatus provides an alert through physical contact between the vibrating detector assembly and the user.

4. An arrangement in accordance with claim 1, wherein; the apparatus utilizes a proximity infrared detector which produces an analog voltage output signal to regulate and provide power to a vibrating micro device throughout a determined range.

5. An arrangement in accordance with claim 1, wherein; the apparatus utilizes a infrared motion detector which produces an output voltage signal to provide power to a vibrating micro device.

6. An arrangement in accordance with claim 1, wherein; the apparatus utilizes an ultrasonic ranging device which produces an analog voltage output signal to regulate and provide power to a vibrating micro device throughout a determined range.

7. An arrangement in accordance with claim 1, wherein; the apparatus utilizes a laser ranging device which produces an analog voltage output signal to regulate and provide power to a vibrating micro device throughout a determined range.

8. An arrangement in accordance with claim 1, wherein; the apparatus utilizes a high frequency radar ranging device which produces an analog voltage output signal to regulate and provide power to a vibrating micro device throughout a determined range.

9. An arrangement in accordance with claims 2, wherein; the output signal of the motion or infrared detector is converted into a visual alert to the user produced by a miniature illumination or digital readout device.

10. An arrangement in accordance with claim 1 and 2, wherein; the apparatus is manufactured in miniature form and worn as headgear to alert the user of object proximity or motion detection events.

11. An arrangement in accordance with claim 1 and 2, wherein; the apparatus is manufactured in miniature form and worn on footwear to alert the user of object proximity or motion detection events.

12. An arrangement in accordance with claim 1 and 2, wherein; the apparatus is manufactured in miniature form and worn on eyeglasses to alert the user of object proximity or motion detection events.

13. An arrangement in accordance with claim 1 and 2, wherein; the apparatus is manufactured in miniature form and worn on a person or animal to alert of object proximity or motion detection events.

14. An arrangement in accordance with claim 7, wherein; the apparatus receives its input signal from an external digital or analog source to activate the alert function.

15. An arrangement in accordance with claim 1, wherein; the alert signal output from the device is converted to high voltage, low current pulses for tactile electrical output response proportional to the distance to the detected object.

16. An arrangement in accordance with claim 1, wherein; the vibrating portion of the apparatus is comprised of a rotating electric direct or alternating current motor with unbalanced fitting at the spinning shaft end.

17. An arrangement in accordance with claim 1, wherein; the vibrating portion of the apparatus is comprised of a solenoid or other device where an oscillating element is displaced by an alternating magnetic field.

18. An arrangement in accordance with claim 4, 5, 6, 7, and 8, wherein; any collective or individual combinations of methods described is utilized for the application.

19. An arrangement in accordance with claim 1, 2, and 3, wherein; the application of the apparatus is underwater.
